(19) United States
(12) Patent Application Publication
(10) Pub. No.: US 2026/0125161 A1
(43) Pub. Date: May 7, 2026

(54) ROTARY AIRCRAFT PASSIVE ROTOR TIP LIGHTING SYSTEM

(71) Applicant: HONEYWELL INTERNATIONAL INC., Charlotte, NC (US)

(72) Inventors: Raeesa Farsana V A, Bangalore (IN); Harish Nagarajaiah, Bangalore (IN)

(73) Assignee: HONEYWELL INTERNATIONAL INC., Charlotte, NC (US)

(21) Appl. No.: 18/985,245

(22) Filed: Dec. 18, 2024

(30) Foreign Application Priority Data
Nov. 5, 2024 (IN) 202411084640

(51) Int. Cl. B64D 47/06; B64C 27/48; G02B 6/36

(52) U.S. Cl. CPC B64D 47/06; B64C 27/48; G02B 6/3604

(57) ABSTRACT

A passive rotor tip lighting system for a rotary aircraft includes a light engine, a supply fiber optic cable, a plurality of rotor fiber optic cables, a plurality of light transmission optics, and a fiber optic rotary joint. The light is configured, upon being energized, to emit a light beam. The supply fiber optic cable is arranged to receive and transmit the light beam emitted by the light engine. Each rotor fiber optic cable is associated with and disposed on or within a different rotor blade. Each light transmission optic is disposed on or within a rotor blades. The fiber optic rotary joint is mounted on, and is rotatable with, the rotor. The fiber optic rotary joint is configured to receive light transmitted from the supply fiber optic cable and supply the light to each of the plurality of rotor fiber optic cables.

### CROSS REFERENCE TO RELATED APPLICATION

The present application claims benefit of prior filed India Provisional Patent Application No. 202411084640, filed Nov. 5, 2024, which is hereby incorporated by reference herein in its entirety.

### TECHNICAL FIELD

The present disclosure generally relates to rotary aircraft, and more particularly relates to a rotary aircraft passive rotor tip lighting system.

### BACKGROUND

Rotary aircraft, such as helicopters, urban air mobility (UAM) aircraft, and unmanned air vehicle (UAV) aircraft, include rotor tip lighting systems. These lighting systems, among other things, improve the visibility of the rotary aircraft to other air traffic, thereby enhancing overall airspace awareness and safety. Current rotor tip lighting systems include light sources on each rotor that are electrically energized using power lines that are routed through the rotor.

Although current rotor tip lighting systems are generally safe and reliable, these current systems do present various challenges. For example, the light sources and associated wiring can be exposed to harsh environmental conditions, such as vibration, lightning, EMI/EMC, temperature variations, and exposure to various other weather phenomena, which can potentially reduce overall system reliability.

Hence, there is a need for a rotor tip lighting system that improves system reliability by not exposing the light sources and associated wiring to various harsh environmental conditions. The present disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a passive rotor tip lighting system for a rotary aircraft that includes a fuselage and at least one rotor that is rotationally mounted on the fuselage and is configured to rotate about a rotational axis, and where the rotor having plurality of rotor blades extending therefrom, the rotor tip lighting system includes a light engine, a supply fiber optic cable, a plurality of rotor fiber optic cables, a plurality of light transmission optics, and a fiber optic rotary joint. The light engine is coupled to the fuselage and is configured, upon being energized, to emit a light beam. The supply fiber optic cable is arranged to receive and transmit the light beam emitted by the light engine. Each rotor fiber optic cable is associated with and disposed on or within a different one of the plurality of rotor blades. Each light transmission optic is disposed on or within a different one of the plurality of rotor blades and is associated with a different one of the rotor fiber optic cables. Each light transmission optic is further disposed to receive light transmitted through its associated rotor fiber optic cable. The fiber optic rotary joint is mounted on, and is rotatable with, the at least one rotor. The fiber optic rotary joint is configured to receive light transmitted from the supply fiber optic cable and supply the light to each of the plurality of rotor fiber optic cables.

In another embodiment, a rotary aircraft includes fuselage, at least one rotor, and a rotor tip lighting system. The at least one rotor is rotationally mounted on the fuselage and is configured to rotate about a rotational axis and has a plurality of rotor blades extending therefrom. The rotor tip lighting system includes a light engine, a supply fiber optic cable, a plurality of rotor fiber optic cables, a plurality of light transmission optics, and a fiber optic rotary joint. The light engine is coupled to the fuselage and is configured, upon being energized, to emit a light beam. The supply fiber optic cable is arranged to receive and transmit the light beam emitted by the light engine. Each rotor fiber optic cable is associated with and disposed on or within a different one of the plurality of rotor blades. Each light transmission optic is disposed on or within a different one of the plurality of rotor blades and is associated with a different one of the rotor fiber optic cables. Each light transmission optic is further disposed to receive light transmitted through its associated rotor fiber optic cable. The fiber optic rotary joint is mounted on, and is rotatable with, the at least one rotor. The fiber optic rotary joint is configured to receive light transmitted from the supply fiber optic cable and supply the light to each of the plurality of rotor fiber optic cables.

In yet another embodiment, a passive rotor tip lighting system for a rotary aircraft that includes a fuselage and a plurality of rotors that are each rotationally mounted on the fuselage and are configured to rotate about a rotational axis, and where each rotor having plurality of rotor blades extending therefrom, the rotor tip lighting system includes a light engine, a plurality of supply fiber optic cables, a plurality of rotor fiber optic cables, a plurality of light transmission optics, and a plurality of fiber optic rotary joints. The light engine is coupled to the fuselage and is configured, upon being energized, to emit a light beam. The supply fiber optic cables are arranged to receive and transmit the light beam emitted by the light engine. The plurality of rotor fiber optic cables includes a subset of rotor fiber optic cables, wherein each subset of rotor fiber optic cables is associated with a different on of the plurality of rotors, and each rotor fiber optic cable in each subset of rotor fiber optic cables is disposed on or within a different one of the plurality of rotor blades of its associated rotor. Each light transmission optic is disposed on or within a different one of the plurality of rotor blades and is associated with a different one of the rotor fiber optic cables. Each light transmission optic is further disposed to receive light transmitted through its associated rotor fiber optic cable. Each fiber optic rotary joint is mounted on, and is rotatable with, a different one of the rotors. Each fiber optic rotary joint is configured to receive light transmitted from one of the supply fiber optic cables and supply the light to one of the subsets of rotor fiber optic cables.

Furthermore, other desirable features and characteristics of the rotary aircraft passive rotor tip lighting system will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a simplified representation of one example embodiment of rotary aircraft that includes a passive rotor tip light system;

FIG. 2 depicts a top view of another example embodiment of a rotary aircraft that includes the passive rotor tip light system;

FIG. 3 is a functional schematic diagram of one embodiment of a passive rotor tip light system that may be included in the example rotary aircraft of FIGS. 1 and 2; and

FIG. N.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

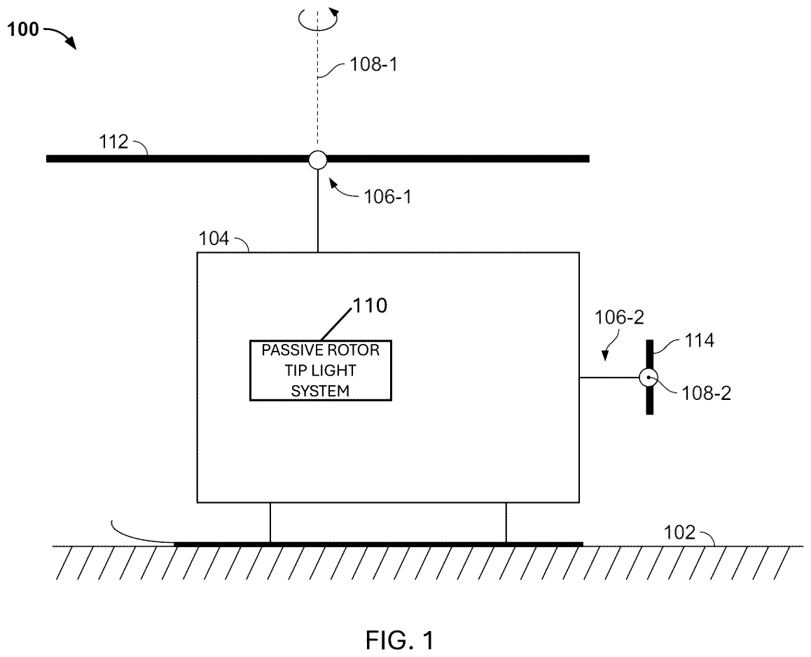

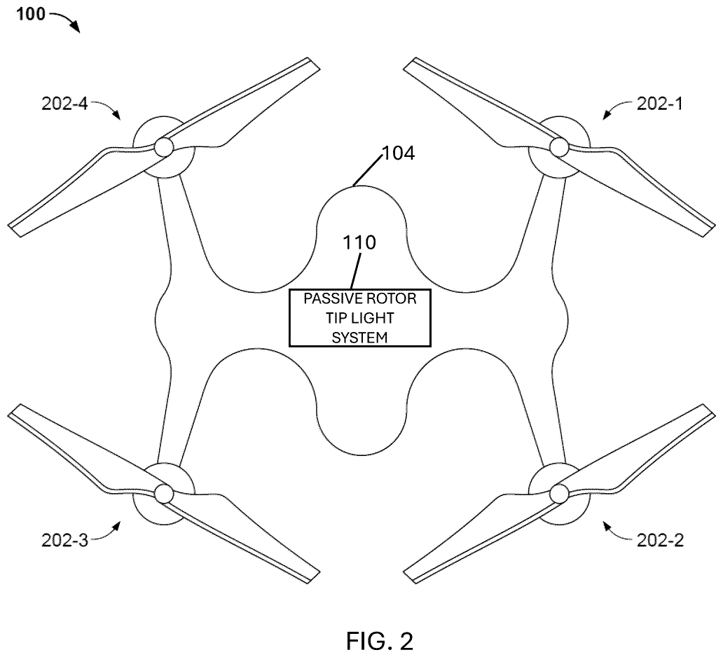

Referring first to FIG. 1, a simplified representation of one example embodiment of rotary aircraft 100 is depicted. The example rotary aircraft 100 is located on a ground surface 102 and includes a fuselage 104 and at least one rotor 106. It is noted that, at least in the depicted embodiment, the rotary aircraft includes two rotors 106—a main rotor 106-1 and a tail rotor 106-2. It will be appreciated, however, that other embodiments may include more or less than this number of rotors 106. For example, the rotary aircraft 100 may be configured as a multi-copter, such as the one depicted in FIG. 2, which includes four rotors 202 (202-1, 202-2, 202-3, 202-4).

Returning now to FIG. 1, regardless of the number of rotors 106 that comprise the rotary aircraft 100, each rotor 106 is rotationally mounted on the fuselage 104 and is configured to rotate about a rotational axis. In particular, the main rotor 106-1 is configured to rotate about a first rotational axis 108-1, and the tail rotor 106-2 is configured to rotate about a second rotational axis 108-2. Each rotor 106-1, 106-2 also has a plurality of blades extending therefrom. In particular, the main rotor 106-1 has a plurality of main rotor blades 112, and the tail rotor 106-2 has a plurality of tail rotor blades 114. With the depicted configuration, and as is generally known, when the main rotor 106-1 rotates, the main rotor blades 112 generate lift and provide vertical and horizontal movement, and when the tail rotor 106-2 rotates, the tail rotor blades 114 counteract torque and stabilize flight. Although the rotary aircraft 100 depicted and described herein includes, for ease of illustration and description, only two main rotor blades 112 and two tail rotor blades 114, it will be appreciated that in other embodiments, the rotary aircraft 100 may include more than this number of main rotor blades 112 and tail rotor blades 114.

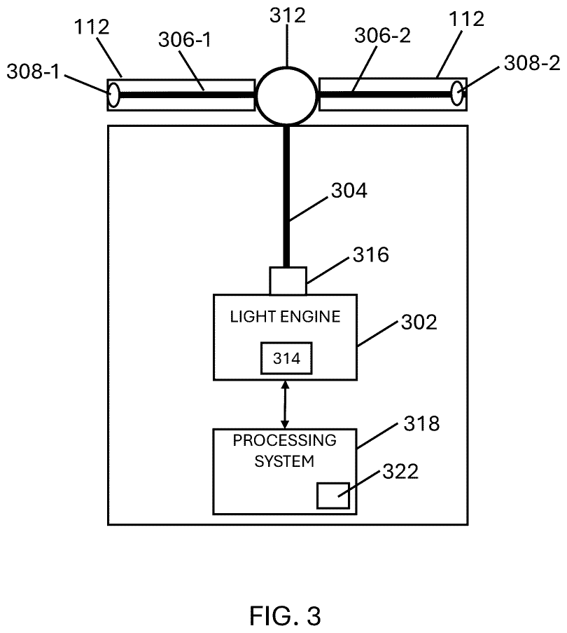

As FIGS. 1 and 2 further depict, the rotary aircraft 100 is equipped with a passive rotor tip lighting system 110. A functional schematic diagram of one embodiment of the passive rotor tip light system 110 is depicted in FIG. 3, and with reference thereto will now be described.

The passive rotor tip lighting system 110 includes a light engine 302, a supply fiber optic cable 304, a plurality of rotor fiber optic cables 306, a plurality of light transmission optics 308, and at least one fiber optic rotary joint 312. The light engine 302 is coupled to the fuselage 104 and is configured, upon being energized, to emit a light beam. It will be appreciated that the light engine 302 may be fully or at least partially disposed within the fuselage 104 or it may be fully or at least partially disposed within one of the rotors 106. In either case, the light engine 302 is not exposed to any potentially harsh conditions to which the rotor blades 112, 114 may be exposed.

Before proceeding further, it is noted that the light engine 302 may be variously configured and implemented. For example, light engine 302 may include any one of numerous types of light sources 314. It will be appreciated that the light sources 314 may be implemented using laser light sources, light emitting diodes (LEDs), light-emitting electrochemical cells, electroluminescent components, lamps, or any other suitable light emitting devices, just to name a few. It will additionally be appreciated that the light engine 302 may be configured such that it may emit the light beam with a wavelength that is in either the visible spectrum (and various colors) or the non-visible spectrum.

Regardless of how the light engine 302 is specifically implemented, it is seen that the supply fiber optic cable 304 is arranged to receive and transmit the light beam emitted by the light engine 302. It should be understood that although the depicted system 100 includes only one supply fiber optic cable 304, in other embodiments the system 100 may include a plurality of supply fiber optic cables 304. For example, when implemented in the rotary aircraft 100 of FIG. 2, the system may include a plurality of supply fiber optic cables 304, with each supply fiber optic cable 304 being associated with a different one of the rotors 202.

The rotor fiber optic cables 306 are each associated with and are disposed on or within a different one of the plurality of rotor blades 112. That is, each rotor fiber optic cable 306 may extend through its associated rotor blade 112 or each rotor fiber optic cable 306 may extend around the outer perimeter of its associated rotor blade 112.

Here too, it should be understood that although the depicted system 100 includes two rotor fiber optic cables 306 (306-1, 306-2), in other embodiments the system 100 may include more than this number of rotor fiber optic cables 306 when, for example, the rotary aircraft 100 includes more than two rotor blades 112.

The light transmission optics 308 are each disposed on or within a different one of the plurality of rotor blades 114. Each light transmission optic 308 (308-1, 308-2) is associated with a different one of the rotor fiber optic cables 306 (306-1, 306-2) and is disposed to receive light transmitted through its associated rotor fiber optic cable 306 (306-1, 306-2). As may be appreciated, for those embodiments that include more than two rotor fiber optic cables 306, the system 100 will also include more than two light transmission optics 308. It will be appreciated that the light transmission optics 308 may be variously implemented. For example, each light transmission optic 308 may comprise one or more lenses, reflectors, and diffusers.

The fiber optic rotary joint 312 is mounted on, and is rotatable with, the rotor 112. The fiber optic rotary joint 312 is configured to receive the light transmitted from the supply fiber optic cable 304 and supply the light to each of the plurality of rotor fiber optic cables 306. It should be understood that although the system 100 is depicted as including only one fiber optic rotary joint 312, in other embodiments the system 100 may include a plurality of fiber optic rotary joints 312. For example, when implemented in the rotary aircraft 100 of FIG. 2, the system may include a plurality of fiber optic rotary joints 312, with each fiber optic rotary joints 312 being associated with a different one of the rotors 202.

In addition to the above components, the passive rotor tip lighting system 110 may, in some embodiments, also include light supply optics 316 and a processing system 318. The light supply optics 316, when included, are disposed between the light engine 302 and the supply fiber optic cable 304. It will be appreciated that the light supply optics 316 may be variously implemented. For example, the light supply optics 316 may include at least one or more collimators and/or one or more gradient-index (GRIN) lenses.

Before proceeding further, it is noted that the processing system 318, when included, preferably includes at least one processor, a communication bus, and a computer readable storage device or media. The processor performs the computation and control functions of the processing system 318. The processor can be any custom made or commercially available processor, a central processing unit (CPU), a graphics processing unit (GPU), an auxiliary processor among several processors associated with the processing system 318, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the processing system 318. The bus serves to transmit programs, data, status and other information or signals between the various components of the aircraft. The bus can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. Although only one processing system 318 is depicted in FIG. 3, other embodiments may include any number of processing systems 318 that communicate over any suitable communication medium or a combination of communication mediums and that cooperate to process various, perform logic, calculations, methods, and/or algorithms, and generate data. In various embodiments, the processing system 318 includes or cooperates with at least one firmware and software program (generally, computer-readable instructions that embody an algorithm) for carrying-out the various process tasks, calculations, and control/display functions described herein. During operation, the processing system 318 may be programmed with and execute at least one firmware or software program, for example, a program 322 that embodies one or more algorithms, to thereby perform the various process steps, tasks, calculations, and control/display functions described herein.

With the above in mind, it is seen that the processing system 318, when included, is in operable communication with the light engine 302 and is configured to selectively energize the light engine 302 to emit the light beam in a predetermined color and/or pattern, such as a steady light beam or a pulsed light beam. The processing system 318 may additionally be configured to selectively energize the light engine 302 to emit the light beam with a wavelength that is in either the visible spectrum or the non-visible spectrum.

The rotary aircraft passive rotor tip lighting system 100 described herein improves system reliability by not exposing the light sources and associated wiring to various harsh environmental conditions.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A passive rotor tip lighting system for a rotary aircraft that includes a fuselage and at least one rotor that is rotationally mounted on the fuselage and is configured to rotate about a rotational axis, the rotor having plurality of rotor blades extending therefrom, the rotor tip lighting system comprising:
a light engine coupled to the fuselage and configured, upon being energized, to emit a light beam;
a supply fiber optic cable arranged to receive and transmit the light beam emitted by the light engine;
a plurality of rotor fiber optic cables, each rotor fiber optic cable associated with and disposed on or within a different one of the plurality of rotor blades;
a plurality of light transmission optics, each light transmission optic disposed on or within a different one of the plurality of rotor blades and associated with a different one of the rotor fiber optic cables, each light transmission optic further disposed to receive light transmitted through its associated rotor fiber optic cable; and
a fiber optic rotary joint mounted on, and rotatable with, the at least one rotor, the fiber optic rotary joint configured to receive light transmitted from the supply fiber optic cable and supply the light to each of the plurality of rotor fiber optic cables; and
a processing system in operable communication with the light engine, the processing system including at least one processor that is configured, by programming instructions, to (i) selectively energize the light engine to emit the light beam in a predetermined color and/or pattern and (ii) selectively energize the light engine to emit the light beam with a wavelength that is in either the visible spectrum or the non-visible spectrum.

2. (canceled)

3. (canceled)

4. The system of claim 1, further comprising:
light supply optics disposed between the light engine and the supply fiber optic cable.

5. The system of claim 4, wherein the light supply optics comprise at least one or more collimators or one or more gradient-index lenses.

6. The system of claim 1, wherein each light transmission optic comprises one or more lenses, reflectors, and diffusers.

7. The system of claim 1, wherein the light engine is at least partially disposed within the fuselage.

8. The system of claim 1, wherein the light engine is at least partially disposed within the at least one rotor.

9. The system of claim 1, wherein each rotor fiber optic cable extends around an outer perimeter of its associated rotor blade.

10. A rotary aircraft, comprising:
a fuselage;
at least one rotor rotationally mounted on the fuselage and configured to rotate about a rotational axis, the at least one rotor having plurality of rotor blades extending therefrom; and
a rotor tip lighting system, the rotor tip light system comprising:
a light engine coupled to the fuselage and configured, upon being energized, to emit a light beam;
a supply fiber optic cable arranged to receive and transmit the light beam emitted by the light engine;
a plurality of rotor fiber optic cables, each rotor fiber optic cable associated with and disposed on or within a different one of the plurality of rotor blades;
a plurality of light transmission optics, each light transmission optic disposed on or within a different one of the plurality of rotor blades and associated with a different one of the rotor fiber optic cables, each light transmission optic further disposed to receive light transmitted through its associated rotor fiber optic cable;
a fiber optic rotary joint mounted on, and rotatable with, the at least one rotor, the fiber optic rotary joint configured to receive light transmitted from the supply fiber optic cable and supply the light to each of the plurality of rotor fiber optic cables; and
a processing system in operable communication with the light engine, the processing system including at least one processor that is configured, by programming instructions, to (i) selectively energize the light engine to emit the light beam in a predetermined color and/or pattern and (ii) selectively energize the light engine to emit the light beam with a wavelength that is in either the visible spectrum or the non-visible spectrum.

11. (canceled)

12. (canceled)

13. The rotary aircraft of claim 10, further comprising:
light supply optics disposed between the light engine and the supply fiber optic cable.

14. The system of claim 13, wherein the light supply optics comprise at least one or more collimators or one or more gradient-index lenses.

15. The rotary aircraft of claim 10, wherein each light transmission optic comprises one or more lenses, reflectors, and diffusers.

16. The rotary aircraft of claim 10, wherein the light engine is at least partially disposed within the fuselage.

17. The rotary aircraft of claim 10, wherein the light engine is at least partially disposed within the at least one rotor.

18. The rotary aircraft of claim 10, wherein each rotor fiber optic cable extends around an outer perimeter of its associated rotor blade.

19. A passive rotor tip lighting system for a rotary aircraft that includes a fuselage and a plurality of rotors that are each rotationally mounted on the fuselage and are configured to rotate about a rotational axis, each rotor having plurality of rotor blades extending therefrom, the rotor tip lighting system comprising:
a light engine coupled to the fuselage and configured, upon being energized, to emit a light beam;
a plurality of supply fiber optic cables arranged to receive and transmit the light beam emitted by the light engine;
a plurality of rotor fiber optic cables, the plurality of rotor fiber optic cables including a subset of rotor fiber optic cables, wherein each subset of rotor fiber optic cables is associated with a different on of the plurality of rotors, and each rotor fiber optic cable in each subset of rotor fiber optic cables is disposed on or within a different one of the plurality of rotor blades of its associated rotor;
a plurality of light transmission optics, each light transmission optic disposed on or within a different one of the plurality of rotor blades and associated with a different one of the rotor fiber optic cables, each light transmission optic further disposed to receive light transmitted through its associated rotor fiber optic cable;
a plurality of fiber optic rotary joints, each fiber optic rotary joint mounted on, and rotatable with, a different one of the rotors, each fiber optic rotary joint configured to receive light transmitted from one of the supply fiber optic cables and supply the light to one of the subsets of rotor fiber optic cables; and
a processing system in operable communication with the light engine, the processing system including at least one processor that is configured, by programming instructions, to (i) selectively energize the light engine to emit the light beam in a predetermined color and/or pattern and (ii) selectively energize the light engine to emit the light beam with a wavelength that is in either the visible spectrum or the non-visible spectrum.
